(19) United States
(12) Patent Application Publication
(10) Pub. No.: US 2023/0051594 A1
(43) Pub. Date: Feb. 16, 2023

(54) INFORMATION PROCESSING APPARATUS AND PROGRAM

(71) Applicant: TOSHIBA TEC KABUSHIKI KAISHA, Tokyo (JP)

(72) Inventors: Hidenori SOMEYA, Ichikawa Chiba (JP); Makoto NISHIDA, Yokohama Kanagawa (JP); Kazuki NAKAMURA, Ota Tokyo (JP)

(21) Appl. No.: 17/870,567

(22) Filed: Jul. 21, 2022

(30) Foreign Application Priority Data
Aug. 10, 2021 (JP) 2021-130491

(51) Int. Cl. G06Q 30/06; G06Q 50/12; G06Q 20/32

(52) U.S. Cl. CPC G06Q 30/0635; G06Q 50/12; G06Q 20/322

(57) ABSTRACT

An information processing apparatus includes a communication interface for receiving order information from a user terminal and a memory unit for storing the received order information in association with a terminal identifier of the user terminal and an order status indicator. The order status indicator identifies one of a plurality of stages in a transaction from order reception to handover of an item to the user. A processor is configured to update the order status associated with the order information in response to an instruction to change an order status that is received from a store terminal. The processor causes a notification to be transmitted the user terminal when the order status associated with the order information is changed to indicate the item is ready for handover.

### CROSS-REFERENCE TO RELATED APPLICATION

This application is based upon and claims the benefit of priority from Japanese Patent Application No. 2021-130491, filed Aug. 10, 2021, the entire contents of which are incorporated herein by reference.

### FIELD

Embodiments described herein relate to information processing devices for food court type order management and notification systems and programs for such information processing devices.

### BACKGROUND

In certain facilities, such as shopping centers, restaurant are often grouped in a food court. In the food court, self-service type ordering services for customers may be provided by which the customers place food orders, then pickup the ordered items and take the items to seats available in the food court. There is an existing system that enables items from any of the restaurants at the food court using terminal devices placed at the tables or the like as well as portable terminal devices such as smartphones possessed by the customers.

When orders are received from customers, the received details of the orders are output to a display unit or the like in the store/restaurant and then generally handled in the received sequence. When the preparation of the ordered item(s) is completed, the customer may be called to pickup the item(s) using a beeper notification system or the like.

However, in systems of related art, the system for managing the cooking or preparation of the ordered item(s) and the system for pickup notification of the customer are generally separate from one another. Thus, there is room for improvement in efficiency and convenience of such systems.

### BRIEF DESCRIPTION OF THE DRAWINGS

FIG. 1 shows an example of a configuration of an order management system according to an embodiment.

FIG. 2 shows an example of a hardware configuration of a user terminal.

FIG. 3 shows an example of a hardware configuration of a server apparatus.

FIG. 4 shows an example of a data configuration of a store information table.

FIG. 5 shows an example of a data configuration of a menu management table.

FIG. 6 shows an example of a data configuration of an order management table.

FIG. 7 shows an example of a hardware configuration of a store terminal.

FIG. 8 depicts functional aspects of a user terminal, a server apparatus, and a store terminal.

FIG. 9 shows an example of an order condition window displayed on a display unit of a store terminal.

FIG. 10 shows an example of a first call operation window.

FIG. 11 shows an example of a second call operation window.

FIG. 12 is a sequence diagram showing an example of an order management process executed in an order management system.

FIG. 13 is a sequence diagram showing an example of another order management process.

FIG. 14 shows another example of an order condition window according to a modified example.

FIG. 15 is a sequence diagram showing an example of another order management process executed in an order management system of a modified example.

### DETAILED DESCRIPTION

An embodiment provides an integrated technology solution to existing problems in the related art concerning multiplicity and integration of different ordering related and order handling store systems and the like. In general, such an embodiment is an improvement over existing, non-integrated systems.

According to one embodiment, an information processing apparatus includes a communication interface for receiving order information from a user terminal. The order information indicates an item of merchandise being order by a user via the user terminal. A memory unit of the apparatus is provided for storing the received order information in association with a terminal identifier of the user terminal and an order status indicator. The order status indicator identifies one of a plurality of stages in a transaction from order reception to handover of the item to the user. A processor is configured to update the order status indicator associated with the order information in the memory unit in response to an instruction to change an order status that is received via the communication interface from a store terminal, and transmit a notification to the user terminal when the order status indicator associated with the order information is changed to indicate the item is ready for handover.

An information processing apparatus and a program for an information processing apparatus according to certain example embodiment will be explained with reference to the drawings. In these examples, such embodiments are applied to a food court provided in a facility such as a shopping mall, but the present disclosure is not limited to these examples.

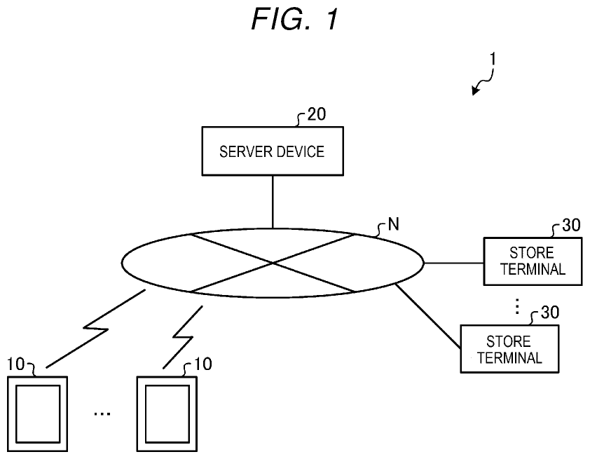

FIG. 1 shows an example of a configuration of an order management system 1 according to an embodiment. As shown in FIG. 1, an order management system 1 includes user terminals 10, a server apparatus 20, and store terminals 30. The user terminals 10, the server apparatus 20, and the store terminals 30 are communicably connected via a network N, such as a LAN (Local Area Network) or a cellular phone line provided in a food court.

The user terminal 10 is a portable terminal device used by a customer using the food court (hereinafter, also referred to as “user”). The user terminal 10 is a terminal device such as a smartphone or a tablet terminal possessed by the customer. The user terminal 10 in some examples may be a dedicated terminal device lent out to a user at the food court. In such a case, the user terminals 10 may be placed on or at tables provided within the food court.

The user terminal 10 is used to order food and drink from stores within the food court (hereinafter, “food and drink” is also referred to as “merchandise”). Specifically, the user terminal 10 provides an operation window for supporting selection of merchandise to be ordered. After receiving a selection of merchandise to be ordered from the user, the user terminal 10 transmits order information indicating the ordered/selected merchandise to the server apparatus 20.

The order information contains, for example, a merchandise ID for identification of the merchandise being ordered, a store ID for identification of the store selling the merchandise being ordered, and a terminal ID for identification of the user terminal 10 sending the order. The terminal ID is a terminal identifier for distinction from another user terminal 10, for example, an IP address, an electronic mail address, a phone number, or the like. Note that, in the present embodiment, the terminal ID is included in the order information and correlated with the order information, however, may be correlated in a form incidental to the order information.

The user terminal 10 cooperatively operates with the server apparatus 20 or an external settlement server, and thereby, the payment for the ordered merchandise can be made by electronic settlement. The method of the electronic settlement is not particularly limited, and any known technique of electronic money or credit card settlement may be used. The order information is enabled on a condition that the settlement of the ordered merchandise is completed. For example, the user terminal 10 may transmit the order information to the server apparatus 20 only if the settlement is first completed. In other examples, the server apparatus 20 may be configured to accept the order information only after settlement is successfully completed.

The user terminal 10 can also be used when the ordered merchandise is handed over to the customer. Specifically, when the preparation of the ordered merchandise is completed at the store to order was placed, the user terminal 10 receives a call notification from the server apparatus 20. When receiving the call notification from the store terminal 30, the user terminal 10 informs the user that the ordered merchandise is ready for pickup by outputting a notice window or sound. Thereby, the user may go to the store and pick up the ordered merchandise.

The server apparatus 20 is an example of an information processing apparatus. The server apparatus 20 is communicably connected to external devices such as the user terminals 10 and the store terminals 30 via the network N. The server apparatus 20 executes various information processes relating to the orders of merchandise by cooperatively operating with the user terminals 10 and the store terminals 30.

For example, the server apparatus 20 provides menu information from the respective stores of the food court to the user terminals 10. The menu information contains, for example, names, prices, explanations, images, etc. of the merchandise sold at the respective stores and relates to display of an operation window on which merchandise can be selected for generating order information.

The server apparatus 20 receives the order information indicating the ordered merchandise from the user terminal 10 and stores and manages the received order information in correlation with the terminal ID of the user terminal 10. Further, the server apparatus 20 stores and manages various statuses showing the cooking condition and the calling condition of the merchandise indicated by the order information in correlation with the order information.

The server apparatus 20 operates to display a window (also referred to as an order condition window) showing a breakdown and various statuses of the merchandise ordered from the store on the store terminal 30. The server apparatus 20 changes the status of the ordered merchandise and calls the user according to an operation instruction received via the order condition window.

Note that the server apparatus 20 in some examples may be configured to electronically settle the payment for the ordered merchandise by cooperatively operating with an external settlement server (e.g., a credit card payment processing service) or the like. In general, any known technique may be used as the method of the electronic settlement. When the server apparatus 20 handles a settlement, it is typically preferable that the server apparatus 20 starts the management of the order information on the condition that the settlement of the ordered merchandise is successfully completed. The server apparatus 20 may calculate the sales amount due with respect to each individual store based on the details of settlement(s) and notify the corresponding store terminal 30 of such details and/or settlement completion.

The store terminal 30 is a terminal device provided in each store of the food court. The store terminal 30 is realized as, for example, a terminal device such as a kitchen display screen placed in the kitchen of the store, a tablet terminal, or the like.

The store terminal 30 displays the order condition window showing the breakdown and various statuses of the ordered merchandise ordered for the store by cooperatively operating with the server apparatus 20. A staff member working in the store performs cooking of the ordered merchandise or the like based on the order condition window displayed on the store terminal 30. Further, when the preparation of the merchandise including cooking and preparation of the ordered merchandise is completed, the staff member performs an operation to call the customer via the order condition window. The store terminal 30 receives the input operation received via the order condition window and notifies the server apparatus 20 of the details of the received input operation.

Next, hardware configurations of the user terminal 10, server apparatus 20, and store terminal 30 will be explained.

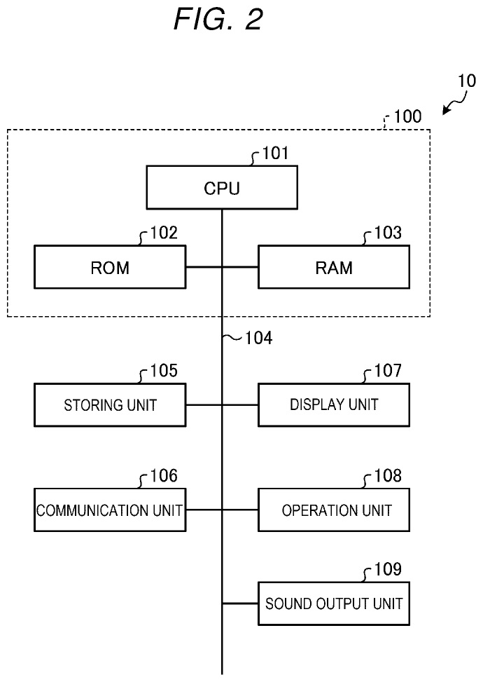

FIG. 2 shows an example of the hardware configuration of the user terminal 10. As shown in FIG. 2, the user terminal 10 includes a CPU (Central Processing Unit) 101, a ROM (Read Only Memory) 102, and a RAM (Random Access Memory) 103.

The CPU 101 is an example of a processor and performs integrated control of the operation of the user terminal 10. The ROM 102 stores various programs. The RAM 103 is a work space in which the programs and various kinds of data are loaded. The CPU 101, the ROM 102, and the RAM 103 are connected via a bus 104 and form a control unit 100. In the control unit 100, the CPU 101 executes various processes by operating according to the programs stored in the ROM 102 and a memory unit 105 and loaded in the RAM 103.

The control unit 100 is connected to the memory unit 105 and a communication unit 106 via the bus 104. The memory unit 105 includes an HDD (Hard Disk Drive) and a flash memory, and maintains the memory contents even when the power is shut down. The memory unit 105 stores various programs executed by the CPU 101 and various kinds of setting information relating to the operation of the user terminal 10. For example, the memory unit 105 stores an application program of a browser relating to display of the menu information provided from the server apparatus 20 or the like. Further, for example, the memory unit 105 stores an electronic mail application, a telephone application, text message application, or the like for processing the call notification from the server apparatus 20.

The communication unit 106 is a wired or wireless communication interface connectable to the network N. The communication unit 106 communicates with external devices including the server apparatus 20 and the store terminals 30 via the network N.

Further, a display unit 107, an operation unit 108, a sound output unit 109, etc. are connected to the control unit 100 via the bus 104.

The display unit 107 is a display device such as an LCD (Liquid Crystal Display) and displays various kinds of information according to control by the control unit 100. The display unit 107 is realized by, for example, a touch-panel display.

The operation unit 108 has various operation buttons and outputs key information in response to the operation by an operator to the control unit 100. Note that the operation unit 108 includes a touch panel provided on the display surface of the display unit 107.

The sound output unit 109 is a sound output device such as a speaker and outputs sound such as beep sound according to the control by the control unit 100.

Note that the hardware configuration of the user terminal 10 is not limited to the example in FIG. 2. For example, when the user terminal 10 is a smartphone, the user terminal 10 may include a communication module of 4G, 5G, or the like and a sound input unit such as a microphone.

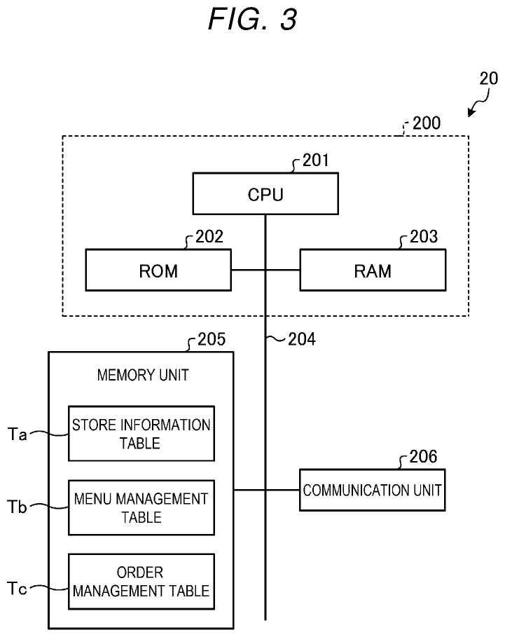

FIG. 3 shows an example of the hardware configuration of the server apparatus 20. As shown in FIG. 3, the server apparatus 20 includes a CPU 201, a ROM 202, and a RAM 203.

The CPU 201 is an example of a processor and performs integrated control of the operation of the server apparatus 20. The ROM 202 stores various programs. The RAM 203 is a work space in which the programs and various kinds of data are loaded. The CPU 201, the ROM 202, and the RAM 203 are connected via a bus 204 and form a control unit 200. In the control unit 200, the CPU 201 executes various processes by operating according to the programs stored in the ROM 202 and a memory unit 205 and loaded in the RAM 203.

The control unit 200 is connected to the memory unit 205 and a communication unit 206 (communication interface) via the bus 204. The memory unit 205 is a memory device. The memory unit 205 may be an HDD and/or a flash memory, and maintains its memory contents even when the power is shut down. The memory unit 205 stores various programs executed by the CPU 201 and various kinds of setting information relating to the operation of the server apparatus 20. The memory unit 205 stores a store information table Ta, a menu management table Tb, an order management table Tc, and the like.

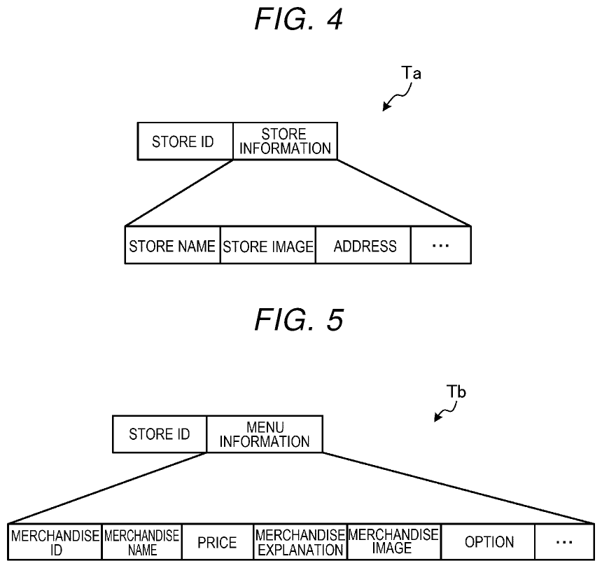

The store information table Ta stores information on the respective stores in the food court. FIG. 4 shows an example of a data configuration of the store information table Ta. As shown in FIG. 4, in the store information table Ta, store information on stores corresponding to store IDs are stored in correlation with the store IDs for identification of the respective stores.

The store information has items, for example, a store name, a store image, an address, etc. Here, the store name is information representing a name, a business name, an abbreviated name, or the like of the store. The store image is image data representing the store including a logo mark of the store, the store name, or the like. The address is address information relating to communication with the store terminal 30 including an IP address, a host name, or the like of the store terminal 30.

The menu management table Tb stores information on merchandise sold in the respective stores. FIG. 5 shows an example of a data configuration of the menu management table Tb. As shown in FIG. 5, in the menu management table Tb, the menu information of the merchandise sold in the store corresponding to the store ID is stored in correlation with the store ID of each store.

The menu information includes items, for example, a merchandise ID, a merchandise name, a price, a merchandise explanation, a merchandise image, an option, etc. The merchandise ID is identification information for identification of each merchandise. The merchandise name is information representing a name or an abbreviated name of the merchandise. The price is information representing a price per unit of the merchandise. In the merchandise explanation, various kinds of information on the merchandise is stored. For example, in the merchandise explanation, information on ingredients contained in the merchandise, a cooking time taken for cooking, etc. are stored.

The merchandise image is image data representing the merchandise. The option is information added when an amount of helping such as “large helping”, toppings, or the like can be designated. For example, the option contains the selectable amounts of helping, selectable kinds of toppings, etc. Further, the option contains information of prices corresponding to options of the amounts of helping and the toppings.

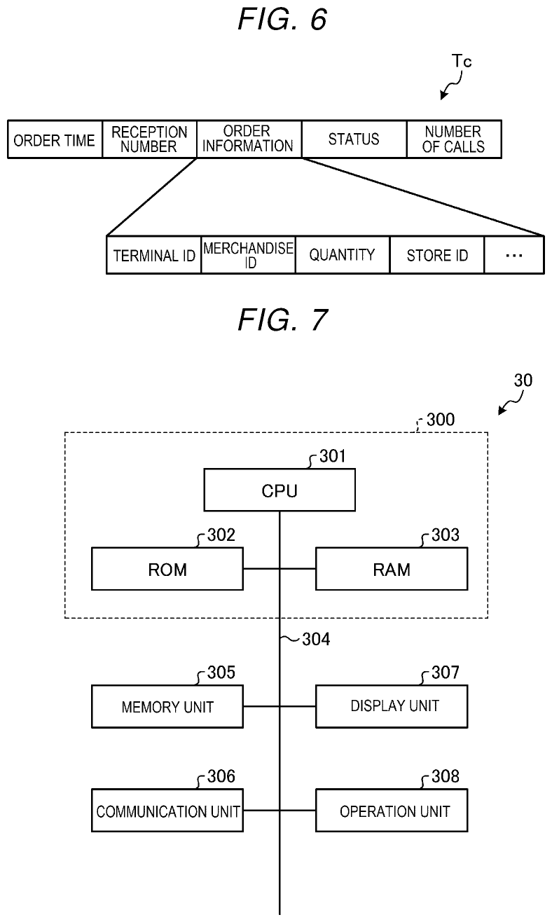

The order management table Tc stores the order information transmitted from the user terminal 10. FIG. 6 shows an example of a data configuration of the order management table Tc. As shown in FIG. 6, in the order management table Tc, information including an order time, a reception number, the order information, the status, the number of calls, etc. are correlated and stored.

Here, the order time is time and date information representing the time and date to receive the order information. The reception number is number information representing a sequence of received order information. For example, ascending numbers are assigned according to the reception sequence of the received the order information (e.g., the reception number increments upward with each additional order).

The order information contains the terminal ID of the user terminal 10 sending the order. The order information also contains the merchandise ID and a quantity of the ordered merchandise and the store ID of the store selling the ordered merchandise. Note that, when options related to the ordered merchandise (e.g., serving size, topping selections, etc.) are available, the details of the selected option(s) are stored in correlation with the corresponding ordered merchandise.

The status shows a state (or condition) relating to the cooking and the handover of the merchandise indicated by the order information. The status is correlated and stored in units corresponding to the store ID contained in the order information. That is, the status shows a state of the ordered merchandise with respect to each store separately.

In the status, of a plurality of stages of states from reception of the order to handover of the merchandise to the user, the current state is stored. For example, in the status, one state of the plurality of stages including “new” showing a state immediately after reception of the order, “cooking” showing a state during cooking of the merchandise, “cooking completed” showing a state that the cooking is completed, “calling” showing a state that the customer is being called, “handover completed” showing a state that the merchandise is handed over to the customer, etc. is stored. The series of states from “new” to “cooking” to “cooking completed” is also referred to as the “cooking condition”.

Further, in the status, of the above described plurality of stages of states, one state may be stored or a plurality of states may be stored in parallel. For example, for some items, the calling of the customer may be performed at different state or time than when the state is changed to cooking is completed, and the state “calling” may be stored (managed) with such another state. In other words, the state “calling” may be managed independently of the cooking condition. In this case, the state “calling” may be stored separate from a state “no calling” that calling is not performed. The states “calling” and “no calling” are also referred to as the “calling condition”. In the present embodiment, an example in which the cooking condition and the calling condition are independently managed is explained.

The number of calls is information representing the number of notifications of call notifications, which will be described later, transmitted to the user terminal 10. The number of calls are correlated and stored in units of store ID contained in the order information. That is, the number of calls shows the number of calls with respect to each store. As will be described later, the server apparatus 20 executes a process of incrementing the number of calls by one at each time when receiving an operation relating to calling of the user from the store terminal 30.

Returning to FIG. 3, the communication unit 206 is a wired or wireless communication interface connectable to the network N. The communication unit 206 communicates with external devices including the user terminals 10 and the store terminals 30 via the network N.

Note that the hardware configuration of the server apparatus 20 is not limited to the example in FIG. 3. For example, in FIG. 3, the server apparatus 20 holds the store information table Ta, the menu management table Tb, and the order management table Tc in the memory unit 205, however, is not limited to the configuration. For example, one or all of the store information table Ta, the menu management table Tb, and the order management table Tc may be held by an external device (e.g., a database server or the like) that can be accessed by the server apparatus 20.

FIG. 7 shows an example of the hardware configuration of the store terminal 30. As shown in FIG. 7, the store terminal 30 includes a CPU 301, a ROM 302, and a RAM 303.

The CPU 301 is an example of a processor and performs integrated control of the operation of the store terminal 30. The ROM 302 stores various programs. The RAM 303 is a work space in which the programs and various kinds of data are loaded. The CPU 301, the ROM 302, and the RAM 303 are connected via a bus 304 and form a control unit 300. In the control unit 300, the CPU 301 executes various processes by operating according to the programs stored in the ROM 302 and a memory unit 305 and loaded in the RAM 303.

The control unit 300 is connected to the memory unit 305 and a communication unit 306 via the bus 304.

The memory unit 305 includes an HDD and a flash memory, and maintains the memory contents even when the power is shut down. The memory unit 305 stores various programs executed by the CPU 301 and various kinds of setting information relating to the operation of the store terminal 30. For example, the memory unit 305 stores an application program of a browser relating to display of the order condition information provided from the server apparatus 20 or the like.

The communication unit 306 is a wired or wireless communication interface connectable to the network N. The communication unit 306 communicates with external devices including the server apparatus 20 via the network N.

Further, a display unit 307 and an operation unit 308 are connected to the control unit 300 via the bus 104.

The display unit 307 is an example of a display device. The display unit 307 is a display device such as an LCD and displays various kinds of information according to control by the control unit 300. The display unit 307 is realized by, for example, a touch-panel display. The operation unit 308 has various operation buttons and outputs key information in response to the operation by the operator to the control unit 300. Note that the operation unit 308 includes a touch panel provided on the display surface of the display unit 307.

Note that the hardware configuration of the store terminal 30 is not limited to the example in FIG. 7. For example, the store terminal 30 may include a printer such as a thermal printer.

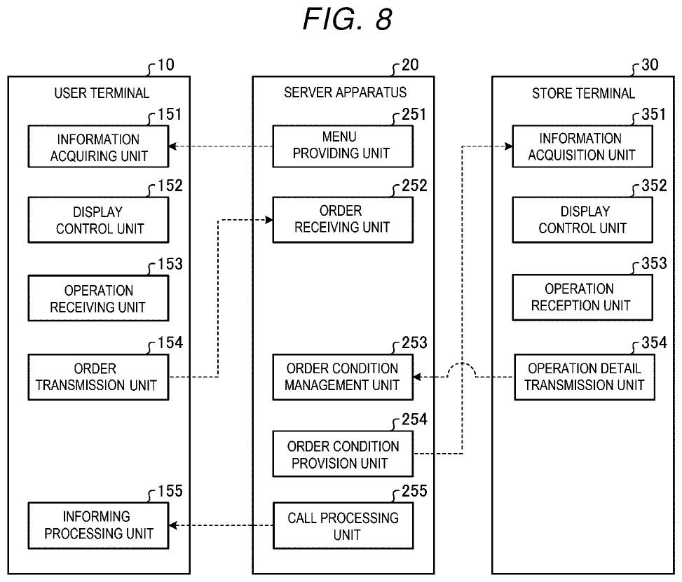

Next, functional aspects of the user terminal 10, the server apparatus 20, and the store terminal 30 will be explained. FIG. 8 shows an example of the functional aspects of the user terminal 10, the server apparatus 20, and the store terminal 30. Note that, in FIG. 8, communications between the apparatuses are indicated by dashed arrows.

The user terminal 10 provides an information acquisition unit 151, a display control unit 152, an operation receiving unit 153, an order transmission unit 154, and an informing processing unit 155 as functional aspects.

Part or all of the functional aspects of the user terminal 10 may be a software implemented function realized by cooperative operation of the processor (e.g., CPU 101) and the program stored in the memory (e.g., ROM 102, the memory unit 105) of the user terminal 10. Furthermore, part or all of the functional aspects of the user terminal 10 may be realized by a dedicated circuit or the like mounted in the user terminal 10 or the like.

The server apparatus 20 provides a menu providing unit 251, an order receiving unit 252, an order condition management unit 253, an order condition provision unit 254, and a call processing unit 255 as functional aspects.

Part or all of the functional aspects of the server apparatus 20 may be a software implemented function realized by cooperative operation of the processor (e.g., CPU 201) and the program stored in the memory (e.g., ROM 202 and/or the memory unit 205) of the server apparatus 20. In some examples, some or all of the functional aspects of the server apparatus 20 may be provided by a hardware configuration realized by a dedicated circuit mounted in the server apparatus 20 or the like.

The order condition management unit 253 is an example of a storage unit and an updating unit. The order condition provision unit 254 is an example of a display unit. The call processing unit 255 is an example of a notification unit.

The store terminal 30 provides an information acquisition unit 351, a display control unit 352, an operation reception unit 353, and an operation detail transmission unit 354 as functional aspects.

Part or all of the functional aspects of the store terminal 30 may be a software implemented function realized by cooperative operation of the processor (e.g., CPU 301) and the program stored in the memory (e.g., ROM 302 and/or the memory unit 305) of the store terminal 30. In some examples, some or all of the functional aspects of the store terminal 30 may be provided a hardware configuration including a dedicated circuit mounted in the store terminal 30 or the like.

The menu providing unit 251 of the server apparatus 20 provides the menu information of the respective stores (store IDs) stored in the menu management table Tb to the user terminals 10. For example, the menu providing unit 251 opens a URL (Uniform Resource Locator) for provision of the menu information on the network N. The menu providing unit 251 provides the menu information of the stores with the store IDs, the store names, etc. of the respective stores to the user terminals 10 accessing the URL. Note that the information on the store may be provided based on the information stored in the store information table Ta.

The information acquisition unit 151 of the user terminal 10 acquires the menu information from the server apparatus 20. For example, the information acquisition unit 151 accesses the URL opened by the server apparatus 20 and acquires the menu information provided from the server apparatus 20.

The display control unit 152 of the user terminal 10 controls the window displayed on the display unit 107. For example, the display control unit 152 controls the display unit 107 to display an operation window (not shown) (hereinafter, also referred to as “order window”) based on the menu information provided from the server apparatus 20 by cooperative operation with the information acquisition unit 151.

In the order window, for example, merchandise sold in the respective stores of the food court are displayed in units of stores, and desired merchandise can be selected with respect to each store or over the plurality of stores by the operation via the operation unit 108. Further, in the order window, an electronic settlement of the selected merchandise can be performed by the user operation. The selected merchandise is activated as the ordered merchandise after completion of the electronic settlement.

The operation receiving unit 153 of the user terminal 10 receives operation input via the operation unit 108 from the user of the user terminal 10. For example, the operation receiving unit 153 receives operation input via the order window displayed on the display unit 107.

The order transmission unit 154 of the user terminal 10 transmits the order information to the server apparatus 20. Specifically, the order transmission unit 154 transmits the order information containing the terminal ID of the user terminal 10 with the merchandise ID, the quantity, the store ID, etc. relating to the ordered merchandise after the completion of the electronic settlement to the server apparatus 20.

The order receiving unit 252 of the server apparatus 20 receives order information from the user terminals 10. Specifically, the server apparatus 20 receives the order information transmitted from each of the user terminals 10 via the communication unit 206.

The order condition management unit 253 of the server apparatus 20 stores and manages the order information of the merchandise ordered for the respective stores in an integrated fashion. Specifically, the order condition management unit 253 sequentially registers the order information received by the order receiving unit 252 in the order management table Tc.

Specifically, the order condition management unit 253 registers the order information received by the order receiving unit 252 in correlation with the reception time and date (order time) of the order information and a newly issued reception number in the order management table Tc. Further, the order condition management unit 253 registers a status “new” relating to the cooking condition, a status “no calling” relating to a handover condition, and a number of calls “0” in correlation with the order information in the order management table Tc. More specifically, the order condition management unit 253 correlates and registers the statuses and the number of calls with respect to each of the same store IDs contained in the order information.

As will be described later, the order condition management unit 253 updates the statuses correlated with the order information or counts the number of calls according to an instruction from the store terminal 30.

The order condition provision unit 254 of the server apparatus 20 provides the order details and the statuses of the merchandise indicated by the order information to the store terminal 30 of the store selling the merchandise based on the order information stored in the order management table Tc.

Specifically, the order condition provision unit 254 extracts the order details (the merchandise ID, the quantity) of the ordered merchandise from the respective order information with respect to each store ID based on the store IDs contained in the order information. Then, the order condition provision unit 254 generates the order condition information representing the breakdown of the ordered merchandise and the statuses based on the order details with respect to each store ID extracted from the respective order information and the order times, the reception numbers, the statuses relating to the order information. Then, the order condition provision unit 254 provides the generated order condition information to the store terminals 30 of the corresponding stores (store IDs).

Note that any method may be used to provide the order condition information. For example, the order condition provision unit 254 may provide in pull control to transmit the order condition information of the corresponding store to the store terminal 30 in response to a request from the store terminal 30. Or, alternatively, the order condition provision unit 254 may provide in push control to transmit the order condition information to the store terminal 30.

The information acquisition unit 351 of the store terminal 30 acquires the order condition information from the server apparatus 20. Specifically, the information acquisition unit 351 acquires the transmitted order condition information by a push or pull provision method from the server apparatus 20.

The display control unit 352 of the store terminal 30 controls the window displayed on the display unit 307. For example, the display control unit 352 controls the display unit 307 to display a window based on the order condition information (hereinafter, also referred to as “order condition window”) provided from the server apparatus 20 by cooperative operation with the information acquisition unit 351. The order condition window will be described later.

The operation reception unit 353 of the store terminal 30 receives operation input via the operation unit 308 from the user of the store terminal 30. For example, the operation reception unit 353 receives operation input to the order condition window displayed on the display unit 307.

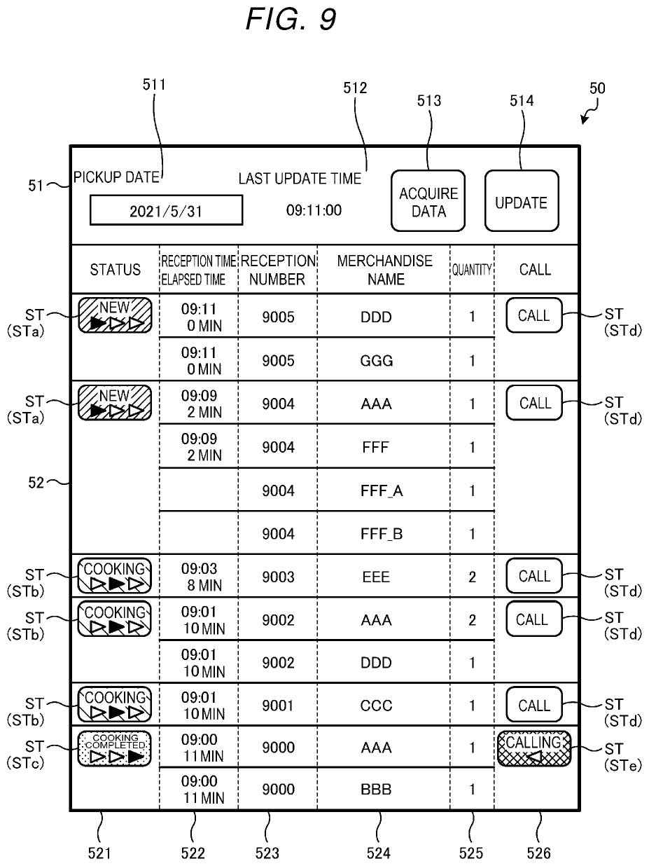

Here, referring to FIG. 9, the order condition window will be explained. FIG. 9 shows an example of the order condition window displayed on the display unit 307 of the store terminal 30. As shown in FIG. 9, an order condition window 50 has a first area 51 and a second area 52.

In the first area 51, the today's date (pickup date 511) and the last time at which the order condition information is acquired (last update time 512) are displayed. Further, in the first area 51, a data acquisition button 513 and an update button 514 are displayed as operators. The data acquisition button 513 is the operator for giving an instruction to acquire the order information. When receiving the operation of the data acquisition button 513, the information acquisition unit 351 requests the order condition information to the server apparatus 20. The update button 514 is the operator for reflecting a change operation of the status, which will be described later.

In the second area 52, the order details of the merchandise ordered from the store are displayed in a list in the sequence of the orders (e.g., by reception time or order number). In FIG. 9, an example in which the order details ordered earlier are displayed in the lower part of the window is explained. The higher in the window the order details are displayed, the later ordered. The order details are displayed by reception numbers.

The second area 52 has a cooking condition display area 521, a time display area 522, a reception number display area 523, a merchandise name display area 524, a quantity display area 525, and a calling condition display area 526 as display items.

The cooking condition display area 521 is an area for displaying the statuses of the cooking condition. In the cooking condition display area 521 the statuses relating to the cooking condition are displayed. Specifically, in the cooking condition display area 521, the statuses relating to the cooking condition are displayed in forms of status images ST such as icons.

The status images ST displayed in the cooking condition display area 521 are prepared for each status of “new”, “cooking”, and “cooking completed”. In the cooking condition display area 521, the status images ST corresponding to the cooking conditions of the respective orders are displayed. In FIG. 9, status images STa show the statuses “new”, status images STb show the statuses “cooking”, and status images STc show the statuses “cooking completed”.

The status images ST displayed in the cooking condition display area 521 function as touchable operators. Specifically, the status images ST displayed in the cooking condition display area 521 are configured to sequentially change from the status image STa (new)→the status image STb (cooking)→the status image STc (cooking completed) in response to the operation via the operation unit 308. Further, the status images ST displayed in the cooking condition display area 521 are configured to circularly change the series of statuses of “new” “cooking”, and “cooking completed”.

The time display area 522 is an area for displaying the reception times of the orders and elapsed times from the reception times. Here, the reception time corresponds to the order time of the corresponding order information stored in the order management table Tc. Further, the elapsed time corresponds to an elapsed time from the reception time to the current time and date. Tracking of the elapsed time may be performed based on the current time and date by a timer such as an RTC (Real Time Clock). Note that the tracking of the elapsed time may be performed at the server apparatus 20 side or at the store terminal 30. In FIG. 9, the reception times and the elapsed times are displayed with respect to each merchandise, however, may be displayed in units of order information.

The reception number display area 523 is an area for displaying the reception numbers of the orders. The reception number corresponds to the reception number of the corresponding order information stored in the order management table Tc. Here, the same reception number is displayed for the merchandise ordered with the same order information. Note that, in FIG. 9, the reception number is displayed with respect to each merchandise, however, may be displayed in units of order information.

The merchandise name display area 524 is an area for displaying the merchandise names of the ordered merchandise. Specifically, in the merchandise name display area 524, the merchandise names corresponding to the merchandise IDs contained in the order information are displayed. The merchandise names may be contained in the order condition information or specified from the merchandise IDs with reference to the menu management table Tb or the like. Note that the merchandise names “FFF_A”, “FFF_B” of the reception numbers “9004” refer to options of the merchandise of the merchandise name “FFF”.

The quantity display area 525 is an area for displaying the quantities of the ordered merchandise. The quantity corresponds to the quantity of the corresponding merchandise contained in the order information.

The calling condition display area 526 is an area for displaying the statuses of the calling condition. In the calling condition display area 526 the statuses relating to the calling condition are displayed. Specifically, in the calling condition display area 526, the statuses relating to the calling condition are displayed in forms of status images ST such as icons.

The status images ST displayed in the calling condition display area 526 are prepared with respect to each status “not calling” and “calling”. In the calling condition display area 526, the status images ST corresponding to the calling conditions of the respective orders are displayed. In FIG. 9, the status images STd show the statuses “not calling” and the status image STe shows the status “calling”.

A user of the store terminal 30 (hereinafter, also referred to as “staff member”) may easily check the list of the orders for the store, the cooking and calling conditions, and the like by viewing the order condition window 50 displayed on the display unit 307.

Further, the staff member may change the cooking and calling conditions by operating the order condition window 50 via the operation unit 308.

Specifically, the staff member may change the cooking conditions and the calling conditions of the respective orders to any of the statuses by operating the status images ST displayed in the cooking condition display area 521 and the calling condition display area 526. Here, the status images ST displayed in the calling condition display area 526 are displayed as touchable operators. Specifically, the status images ST displayed in the calling condition display area 526 are configured to change in the sequence from the status image STd (not calling) to the status image Ste (calling).

For example, when starting the cooking of the ordered merchandise, the staff member changes the status image Sta to the status image STb by single touch operation thereon. Further, when the cooking of the ordered merchandise is completed, the staff member changes the status image STb to the status image STc by single touch operation thereon.

As described above, at the store terminal 30, the staff member may easily track and manage the cooking condition of the ordered merchandise by changing the status of the status image ST displayed in the cooking condition display area 521 according to the cooking condition of the ordered merchandise. At the store terminal 30, the processing conditions of the orders may be shared with another staff member via the order condition window 50.

The operation detail transmission unit 354 of the store terminal 30 notifies the server apparatus 20 of the status of the cooking condition after change by the operation of the staff member as the operation details by cooperative operation with the operation reception unit 353. For example, when receiving the operation of the update button 514 after the status of the cooking condition is changed, the operation detail transmission unit 354 notifies the server apparatus 20 of the status of the changed cooking condition as the operation details.

Here, the operation details transmitted by the operation detail transmission unit 354 contain the store ID of the transmitting store, the reception number of the relevant order, and the changed status. Note that, in the server apparatus 20, when the store ID are specified by the IP address of the store terminal 30 transmitting the operation details or the like, the store ID need not be explicitly contained in the transmitted operation details.

Furthermore, in an embodiment, the notification of the changed cooking condition is given whenever the update button 514 is operated, however, in some examples, the notification of the changed cooking condition may be made when the status images STa to STc are operated/changed. Note that, with the operation of the update button 514 as a trigger, when the cooking condition is changed by erroneous operation of the status images STa to STc, immediate notification of the erroneous cooking condition to the server apparatus 20 may be suppressed, and the user convenience may be improved.

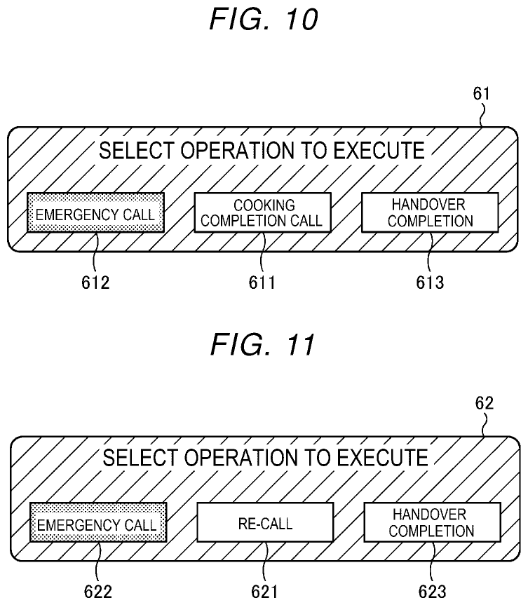

When calling the customer to the store, the staff member operates the status image ST (STd, STe) displayed in the calling condition display area 526. When receiving the input operation on the status image STd, the display control unit 352 controls the display unit 307 to display an operation window shown in FIG. 10 (hereinafter, also referred to as “first call operation window”) to prompt the staff member to perform an additional operation relating to calling of the customer.

Here, FIG. 10 shows an example of the first call operation window displayed on the display unit 307 of the store terminal 30. As shown in FIG. 10, in a first call operation window 61, a cooking completion call button 611, an emergency call button 612, and a handover completion button 613 are displayed as operators.

The cooking completion call button 611 is a call button used when the merchandise completed in cooking is handed over to the customer. Note that, for example, the cooking completion call button 611 may be hidden or deactivated not to be operated for the order having the status relating to the cooking condition as “new” and “cooking”.

The emergency call button 612 is a call button used for an emergency not related to the handover of the merchandise (e.g., an ordering error or situation is noticed that prevents completion of the order as presented to the store). Note that the emergency call button 612 can be constantly available, however, in some examples, it may be deactivated when the cooking completion call button 611 is active.

In the order condition window 50, when the cooking completion call button 611 or the emergency call button 612 is operated, the status of “not calling” displayed in the calling condition display area 526 is changed to “calling”. Further, when the calling condition is changed to “calling”, the operation detail transmission unit 354 notifies the server apparatus 20 of the changed status of the calling condition as the operation details. The operation details contain the store ID of the store, the reception number of the relevant order, and the changed status like those described as above.

Note that, in an embodiment, the status “not calling” is changed to the status “calling” in response to the operation on the cooking completion call button 611 or the emergency call button 612, however, the embodiments are not limited to this. For example, without display of the first call operation window 61, the status may be directly changed to the status “calling” (status image STe) in response to the operation on the status image STd.

Or a confirmation window for the staff member to confirm whether or not to call may be displayed after the operation on the cooking completion call button 611 or the emergency call button 612. In this case, the order condition window 50 changes the status to the status “calling” on a condition that confirmation of calling may be obtained. Note that, in this case, the contents of the confirmation window may be made different between the cooking completion call button 611 or the emergency call button 612. For example, when the emergency call button 612 is operated, input of a predetermined password or the like may be requested for preventing erroneous operation.

The handover completion button 613 is a call button used when the handover of the merchandise is completed. For example, the handover completion button 613 is used when the handover of the merchandise is completed without calling of the customer. When the handover completion button 613 is operated, the operation detail transmission unit 354 of the store terminal 30 notifies the server apparatus 20 of the store ID of the store, the reception number of the relevant order, and the status “handover completed” as the operation details.

Note that, after the notification of the operation details by the operation detail transmission unit 354, the display control unit 352 erases the first call operation window 61 and displays the order condition window 50 shown in FIG. 9 again.

When receiving the operation on the status image STe displayed in the calling condition display area 526, the display control unit 352 controls the display unit 307 to display an operation window relating to calling of the customer (hereinafter, also referred to as “second call operation window”) as shown in FIG. 11.

FIG. 11 shows an example of the second call operation window displayed on the display unit 307 of the store terminal 30. As shown in FIG. 11, in a second call operation window 62, a re-call button 621, an emergency call button 622, and a handover completion button 623 are displayed as operators.

The re-call button 621 is a call button used when calling of the customer is performed again. The emergency call button 622 is a call button used for emergency or unusual situation not specifically concerning the calling of the customer for the handover of the merchandise. The handover completion button 623 is a call button used when the handover of the merchandise is completed. For example, the handover completion button 623 is to be pressed after the handover of the merchandise to the called customer is successfully completed.

When the operation on each operator in the second call operation window 62 is performed, the operation detail transmission unit 354 of the store terminal 30 notifies the server apparatus 20 of the operation details like the first call operation window 61. After the notification of the operation details by the operation detail transmission unit 354, the display control unit 352 erases the second call operation window 62 and displays the order condition window 50 shown in FIG. 9 again.

Note that, even when the re-call button 621 or the emergency call button 622 is operated, the status does not change because the customer is already being called, however, the notification of the status “calling” is given again as the operation details after change (update).

In some examples, a confirmation window for the staff member to confirm whether or not to call may be displayed after the operation of the re-call button 621 or the emergency call button 622, and the status may be changed to the status “calling” again on a condition that confirmation of calling may be obtained. Note that, like the above described cooking completion call button 611 and emergency call button 612, the contents of the confirmation window may be made different between the re-call button 621 and the emergency call button 622.

Returning to FIG. 8, the order condition management unit 253 of the server apparatus 20 receives the operation to give an instruction to change the status from the store terminal 30. Specifically, the order condition management unit 253 receives the operation details performed on the order condition window of the notification from the store terminal 30 (functioning as the operation detail transmission unit 354).

Further, the order condition management unit 253 updates the status stored in the order management table Tc based on the changed status of the instruction from the store terminal 30. Specifically, the order condition management unit 253 specifies the order information of the store ID having the status to update based on the reception number and the store ID contained in the operation details. Then, the order condition management unit 253 updates the status relating to the specified order information to the status of the instruction by the operation details.

For example, when the status of the cooking condition of the instruction by the operation details is “cooking”, the order condition management unit 253 updates the status relating to the cooking condition of the corresponding order information to “cooking”. Or, when the status of the calling condition of the instruction by the operation details is “calling”, the order condition management unit 253 updates the status relating to the calling condition of the corresponding order information to “calling”. Note that the order condition management unit 253 increments the number of calls correlated with the corresponding order information by one at each time when updating to the status “calling”.

Then the order condition provision unit 254 generates (updates) the order condition information of the store relating to the updated status in response to the updating of the order management table Tc and provides the corresponding order condition information to the store terminal 30 of the corresponding store.

By cooperative operation of the above described server apparatus 20 and the store terminal 30, the details of the status changed (updated) by the staff member operation is reflected on the order management table Tc and the reflected order condition information (order condition window 50) is provided to the store terminal 30. Thereby, the staff member may easily track and manage the status relating to the cooking condition and the handover condition of the merchandise ordered to the store using the order condition window 50 displayed on the display unit 370.

When receiving the operation details giving an instruction of a status “handover completed”, the order condition management unit 253 may update the status of the corresponding order information to a predetermined status showing “handover completed”. In this case, the order condition provision unit 254 may generate the order condition information in which the order information of the status “handover completed” is hidden and provide the information to the store terminal 30 of the corresponding store. Thereby, the merchandise completed in handover is erased from the order condition window 50 and a list of orders being currently processed and to be processed is displayed in the order condition window 50.

Or when receiving the operation details of the instruction of a status “handover completed”, the order condition management unit 253 may delete the corresponding order information from the order management table Tc or move the corresponding order information to another table. In the latter case, the order condition provision unit 254 may separately generate order history information (order history window) that can display a list of the order information of the handed over orders with respect to each store based on the table as the movement destination and provide the information to the store terminal 30. For example, the display control unit 352 of the store terminal 30 switches and displays between the order condition window 50 and the order history window according to the operation via the operation unit 308. Thereby, in the store, the list of the order information of the completed handover of merchandise may be confirmed via the display unit 307, and the convenience may be improved.

When the status of the order information stored in the order management table Tc is updated to the status showing the stage at which the merchandise can be handed over, the call processing unit 255 of the server apparatus 20 transmits a call notification for calling the user to the store to the user terminal 10.

Specifically, when the status of the calling condition is updated to “calling”, the call processing unit 255 specifies the terminal ID correlated with the order information of the corresponding status from the order management table Tc. Further, the call processing unit 255 specifies the store name and the merchandise name from the store information table Ta and the menu management table Tb based on the store ID and the merchandise ID correlated with the status “calling”. Then, the call processing unit 255 transmits a call notification containing the store name and the merchandise name specified from the store information table Ta and the menu management table Tb to the user terminal 10 corresponding to the specified terminal ID.

Any method may be used to give the call notification, and the notification may be given using, for example, electronic mail, messenger, telephone, or the like. Or the call processing unit 255 may change the notification method based on the number of calls stored in the order management table Tc. For example, when the number of calls is one to four, the call notification may be given by electronic mail and, when the number of calls is five or more, the call notification may be given by telephone.

The notification method or the calling method of the user can be changed according to the number of calls previously sent, and thereby, a user who has not been reached by a single calling method can be called by another calling method. Therefore, the chances to make the user aware of a calling for order pickup or the like may be increased.

The informing processing unit 155 of the user terminal 10 executes an informing process for informing the user of the user terminal 10 of the call notification from the server apparatus 20.

For example, when receiving the call notification by electronic mail, the informing processing unit 155 cooperatively operates with an electronic mail application preinstalled in the user terminal 10, and thereby, displays the contents of the notification by electronic mail on the display unit 107 and outputs sound from the sound output unit 109.

When receiving the call notification by telephone from the server apparatus 20, the informing processing unit 155 cooperatively operates with a telephone application preinstalled in the user terminal 10, and thereby, displays the reception of a telephone call on the display unit 107 and outputs contents of the call notification by artificial voice or the like from the sound output unit 109.

Then, the user of the user terminal 10 receiving the information from the informing processing unit 155 may go to the notifying store and pick up the merchandise ordered by the user. In this manner, the order management system 1 performs integrated management of the statuses at the series of transaction stages from merchandise order reception to the handover of the merchandise to the user.

Operation examples of the user terminal 10, server apparatus 20, and store terminal 30 will be explained.

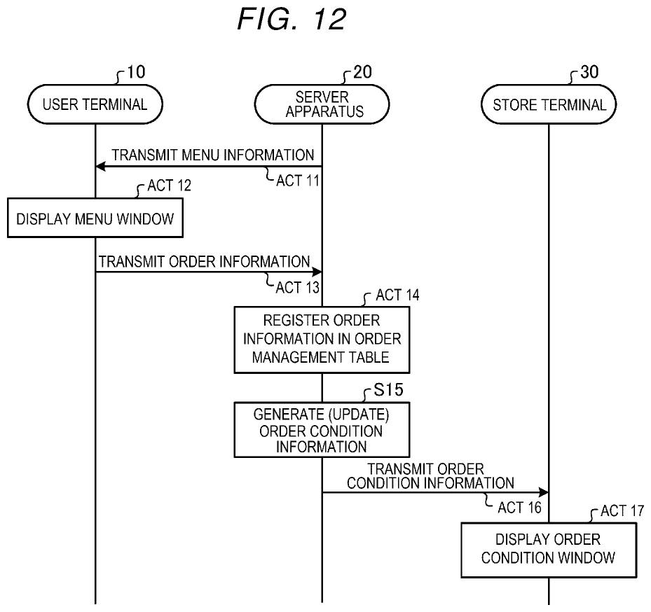

First, referring to FIG. 12, a first order management process executed in the order management system 1 is explained. FIG. 12 is a sequence diagram showing an example of the first order management process executed in the order management system 1.

First, the menu providing unit 251 of the server apparatus 20 transmits (provides) the menu information to the user terminal 10 in response to access from the user terminal 10 or the like (ACT 11).

In the user terminal 10, when the menu information is provided from the server apparatus 20, the information acquisition unit 151 acquires the provided menu information. The display control unit 152 controls the display unit 107 to display the menu window based on the menu information provided from the server apparatus 20 (ACT 12). Thereby, the user of the user terminal 10 may perform selection and settlement processes based on the displayed menu window.

Subsequently, when the selection and settlement processes are completed, the order transmission unit 154 transmits the order information containing the merchandise ID of the ordered merchandise and the store ID of the corresponding seller, the terminal ID of the ordering user terminal 10, etc. to the server apparatus 20 (ACT 13). In the server apparatus 20, the order receiving unit 252 receives and accepts the order information transmitted from the user terminal 10 via the communication unit 206. Here, the order receiving unit 252 may transmit a positive response (e.g., an acknowledgement or confirmation) to the user terminal 10 indicating the reception of the order information.

When the order receiving unit 252 receives new order information, the order condition management unit 253 registers the order information in the order management table Tc (ACT 14). The order condition provision unit 254 generates (updates) order condition information relating to the store where updating occurs in response to the updating of the order management table Tc (ACT 15). Then, the order condition provision unit 254 transmits (provides) the order condition information generated by the order condition management unit 253 to the store terminal 30 of the corresponding store (ACT 16).

In the store terminal 30, the information acquisition unit 351 acquires the order condition information provided from the server apparatus 20. The display control unit 352 controls the display unit 307 to display the order condition window based on the order condition information (ACT 17).

Thereby, in the store, at each time when a new order is received, the order condition window on which the order details are reflected is displayed on the store terminal 30.

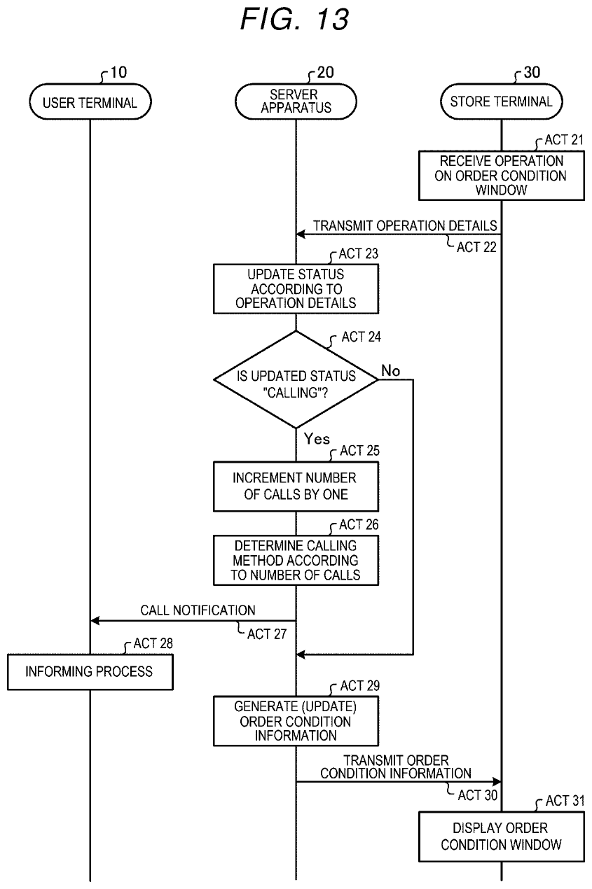

Next, referring to FIG. 13, a second order management process executed in the order management system 1 will be explained. FIG. 13 is a sequence diagram showing an example of the second order management process executed in the order management system 1. Note that, the process description is made in this example on the assumption that the order condition window is displayed on the display unit 307 of the store terminal 30.

In the store terminal 30, the operation reception unit 353 receives an input operation on the order condition window displayed on the display unit 307 (ACT 21). For example, the operation reception unit 353 receives an operation related to the cooking condition or the calling condition displayed in the order condition window. The operation detail transmission unit 354 transmits (gives a notification of) the operation details received by the operation reception unit 353 to the server apparatus 20 (ACT 22).

In the server apparatus 20, the order condition management unit 253 receives the operation details transmitted from the store terminal 30. Then, the order condition management unit 253 updates the status of the order information corresponding to the reception number and the store ID sending the instruction related to the changed/updated operation details (or status change) (ACT 23).

Subsequently, the order condition management unit 253 determines whether or not the updated status updated at ACT 23 is “calling” (ACT 24). Here, when the updated status is something other than “calling” (ACT 24; No), the process goes to ACT 29.

On the other hand, when the updated status is “calling” (ACT 24; Yes), the order condition management unit 253 increments the number of calls relating to the updated merchandise by one (ACT 25). The call processing unit 255 determines the calling method corresponding to the number of calls with the updating process of the status or the number of calls by the order condition management unit 253 (ACT 26). Then, the call processing unit 255 gives the call notification to the user terminal 10 of the terminal ID correlated with the reception number by the calling method determined at ACT 26 (ACT 27), and the process goes to ACT 29. On the other hand, in the user terminal 10 receiving the call notification, the informing processing unit 155 executes the informing process based on the call notification (ACT 28).

In the server apparatus 20, at ACT 29, the order condition provision unit 254 generates the order condition information on which the updated contents of the order management table Tc are reflected and updates the order condition information (ACT 29). Then, the order condition provision unit 254 provides (transmits) the order condition information generated at ACT 29 to the relevant store terminal 30 (ACT 30).

Then, in the store terminal 30, when the updated order condition information is acquired by the information acquisition unit 351, the display control unit 352 controls the display unit 307 to display the order condition window based on the order condition information (ACT 31).

As described above, in the order management system 1, when the status of the order information managed in the server apparatus 20 is updated in response to the operation to change the status in the store terminal 30 and the updated status shows the stage at which the merchandise can be handed over, calling of the user of the order may be automatically performed. Thereby, in the order management system 1, in the statuses at the stages from the order reception of the merchandise to the handover of the merchandise to the user, the operation to change the status and the calling of the user may be performed in cooperation with each other, and the management of the ordered merchandise may be efficiently performed.

In the order management system 1, a staff member of the store may call the user based on the order condition information (order condition window) provided by the server apparatus 20. Thereby, in each store, the staff member may call the user at any time while confirming the order details of the ordered merchandise, and the management of the ordered merchandise may thus be efficiently performed.

Various modification to embodiments can be implemented by appropriate modification to change part of the configurations or functions of the above described examples. Accordingly, several modified examples will be particularly explained as further embodiments. Note that, in the description of these additional modified examples, the differences from the already explained embodiments will be primarily discussed and the detailed explanation of the points in common with the already described examples will be omitted. Furthermore, these modified examples may be individually implemented or appropriately combined and implemented with one another.

### Modified Example 1

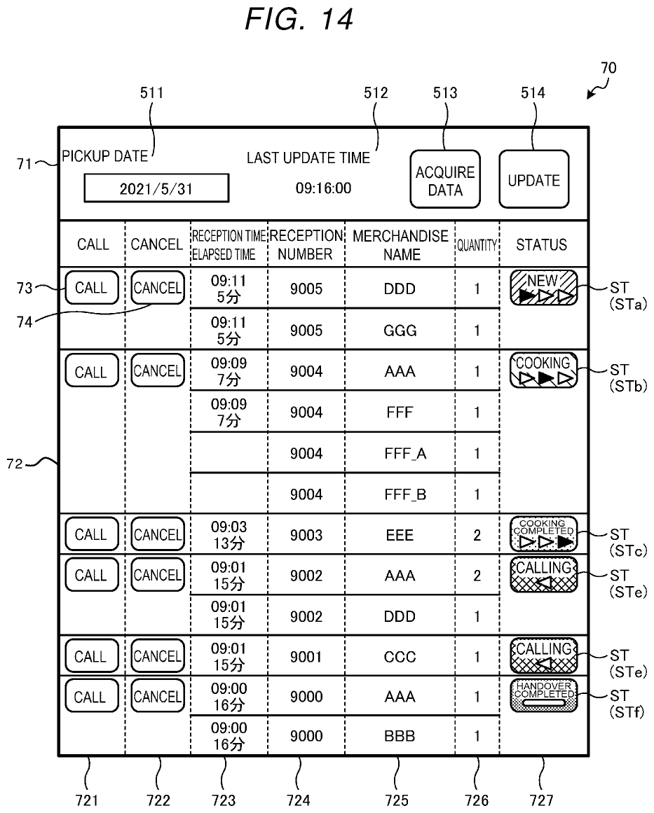

In an embodiment, in the order condition window 50 explained in FIG. 9, the cooking condition and the calling condition are displayed in the cooking condition display area 521 and the calling condition display area 526, respectively. However, the display form of the order condition window is not limited to this, and in other examples the cooking condition and the calling condition may be displayed in the same display area such as shown in FIG. 14.

FIG. 14 shows an example of the order condition window displayed on the display unit 307 of the store terminal 30 according to this modified example. As shown in FIG. 14, an order condition window 70 has a first area 71 and a second area 72. Here, the first area 71 has the same configuration as the above described first area 51.

In the second area 72, the order details of the merchandise ordered to the store itself are displayed in a list. The second area 72 has a call operation area 721, a cancel operation area 722, a time display area 723, a reception number display area 724, a merchandise name display area 725, a quantity display area 726, and a status display area 727. Here, the time display area 723, the reception number display area 724, the merchandise name display area 725, and the quantity display area 726 correspond to the above described time display area 522, reception number display area 523, merchandise name display area 524, and quantity display area 525, respectively.

In the calling operation area 721, call buttons 73 for giving instructions to call customers are displayed. One calling button 73 is displayed with respect to each order (reception number). When receiving the operation of the call button 73, the operation detail transmission unit 354 transmits instruction information for giving an instruction to call containing the reception number relating to the order of the operated call button 73 and the store ID of the store itself (hereinafter, also referred to as “call instruction”) to the server apparatus 20 as the operation details. Note that, in general, the call button 73 can be operated at any time independent of the actual statuses of the cooking condition and the calling condition.

In the cancel operation area 722, cancel buttons 74 for giving instructions to cancel the orders are displayed. The cancel button 74 is displayed with respect to each order (reception number). When receiving the operation of the cancel button 74, the operation detail transmission unit 354 transmits instruction information for giving an instruction to cancel containing the reception number relating to the order of the operated cancel button 74 and the store ID of the store itself (hereinafter, also referred to as “cancel instruction”) to the server apparatus 20 as the operation details. Note that, in general, the cancel button 74 can be operated at any time independent of the actual statuses of the cooking condition and the calling condition.

The status display area 727 is an area for displaying the cooking condition and the calling condition. In the status display area 727, statuses relating to the cooking condition and the calling condition correlated with the merchandise IDs of the ordered merchandise are displayed. Specifically, in the status display area 727, the statuses of the cooking condition and the calling condition are displayed in forms of status images ST such as icons.

Here, an example in which the series of statuses relating to cooking to handover of the ordered merchandise is divided in five stages of “new”, “cooking”, “cooking completed”, “calling”, and “handover completed” is shown. In FIG. 14, a status image STa shows the status “new”, a status image STb shows the status “cooking”, a status image STc shows the status “cooking completed”, status images STe show the statuses “calling”, and a status image STf shows the status “handover completed”.

The status images ST displayed in the status display area 727 are displayed as touchable operators.

A user of the store terminal 30 (hereinafter, also referred to as “staff member”) may easily check the list of the orders for the store, the cooking and calling conditions, etc. by viewing the order condition window 70 displayed on the display unit 307 like the order condition window 50.

Further, the staff member may update (change) the cooking and calling conditions by operating the order condition window 70 via the operation unit 308.

Specifically, the staff member may change the cooking conditions and the calling conditions of the respective orders to any of the available statuses by operating the status images ST displayed in the status display area 727. Here, the status images ST displayed in the status display area 727 are configured to change in sequence from the status image STa (new) to the status image STb (cooking) to the status image STc (cooking completed) to the status image STe (calling) to the status image STf (handover completed) in response to the pressing or selection of the operation unit 308.

The operation detail transmission unit 354 of the store terminal 30 notifies the server apparatus 20 of the status of the cooking condition changed by the operation of the staff member as the operation details by cooperative operation with the operation reception unit 353. For example, when receiving the operation of the update button 514 after the status in the status display area 727 is changed, the operation detail transmission unit 354 notifies the server apparatus 20 of the changed status as the operation details like the above described embodiment.

In the order management system 1 according to the modified example, by the cooperative operation of the server apparatus 20 and the store terminal 30, the details changed (updated) by the staff member operation are reflected on the order management table Tc and the updated order condition information (order condition window 70) is provided to the store terminal 30. Thereby, the staff member may easily check the list of the orders to the store, the latest cooking and calling conditions, and the like by viewing the order condition window 70 displayed on the display unit 307 like the order condition window 50.

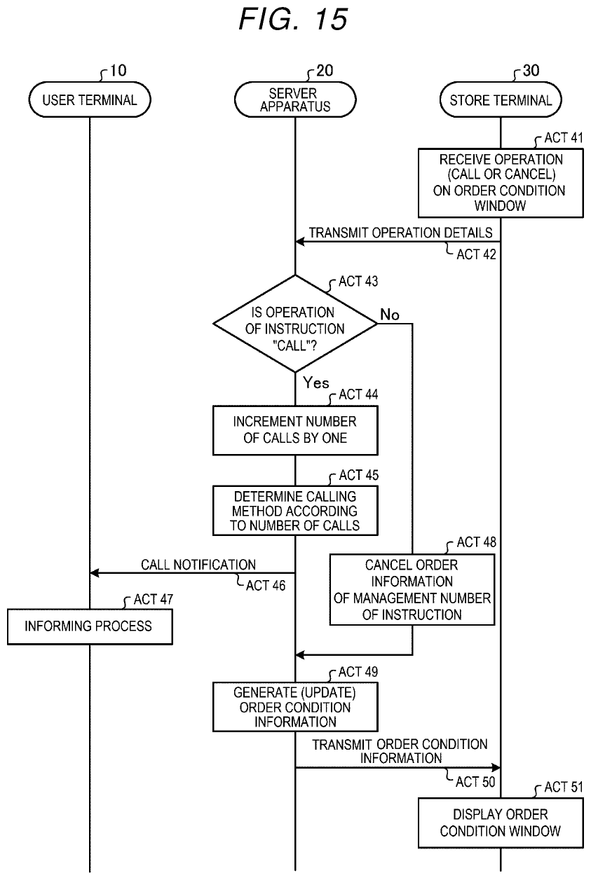

Next, referring to FIG. 15, a process executed by the order management system 1 of the modified example will be explained. FIG. 15 is a sequence diagram showing an example of a third order management process executed in the order management system 1 of the modified example. Note that the third order management process is mainly a process when the above described call button 73 and cancel button 74 are operated.

First, in the store terminal 30, the operation reception unit 353 receives an operation on the order condition window 70 displayed on the display unit 307 (ACT 41). Here, when the operation reception unit 353 receives the operation on the call button 73 or the cancel button 74, the operation detail transmission unit 354 transmits (notifies) the operation details received by the operation reception unit 353 to the server apparatus 20 (ACT 42).

In the server apparatus 20, the order condition management unit 253 receives the operation details transmitted from the store terminal 30. Then, the order condition management unit 253 determines whether the operation details received from the store terminal 30 are a call instruction or a cancel instruction (ACT 43).

When the operation details received at ACT 43 are the call instruction (ACT 43; Yes), the order condition management unit 253 increments the number of calls relating to the merchandise specified by the reception number and the store ID contained in the call instruction by one (ACT 44). Further, the call processing unit 255 determines the calling method corresponding to the number of calls with the updating process of the number of calls by the order condition management unit 253 (ACT 45). Then, the call processing unit 255 gives the call notification to the user terminal 10 of the terminal ID correlated with the reception number using the calling method determined at ACT 45 (ACT 46), and the process goes to ACT 49. On the other hand, in the user terminal 10 receiving the call notification, the informing processing unit 155 executes the informing process based on the call notification (ACT 47).

At ACT 43, when the received operation details are the cancel instruction (Act 43; No), the order condition management unit 253 executes the cancel process of the order information relating to the reception number and the store ID contained in the cancel instruction (ACT 48), and the process goes to ACT 49.

For example, the condition management unit 253 executes the cancel process of the order information of the instruction by deleting the order information of the cancel instruction from the order management table Tc or moving the order information to another table. Further, for example, the order condition management unit 253 executes the cancel process of the order information of the instruction by updating the status of the merchandise (merchandise ID) of the cancel instruction to a status “cancelled”. Note that the order condition management unit 253 may additionally perform a refund process of returning the payment of the cancelled merchandise to the customer by cooperative operation with another system.

In the server apparatus 20, at ACT 49, the order condition provision unit 254 generates the order condition information on which the updated contents of the order management table Tc are reflected and updates the order condition information (ACT 49). Then, the order condition provision unit 254 provides (transmits) the order condition information generated at ACT 49 to the relevant store terminal 30 (ACT 50).

Then, in the store terminal 30, when the updated order condition information is acquired by the information acquisition unit 351, the display control unit 352 controls the display unit 307 to display the order condition window based on the order condition information (ACT 51).

As described above, according to the order management system 1 of the modified example, the staff member of the store may call the user and cancel the order based on the order condition information (order condition window) provided by the server apparatus 20. Thereby, in each store, the staff member may call the user or cancel the order at any time while confirming the order details of the merchandise ordered, and the management of the ordered merchandise may thus be efficiently performed.

### Modified Example 2

In an embodiment, the statuses of the ordered items of merchandise are managed on a per store basis (that is, by store IDs). However, the management of the statuses is not limited to this, and the statuses may be managed by merchandise type (e.g., merchandise IDs or merchandise category) and/or the by orders (e.g., by reception number).

For example, when the statuses are managed by merchandise type, the statuses are held in correlation with the respective merchandise contained in the order information. Further, in the order condition window, the status images ST of the cooking condition and the calling condition can be displayed for each individual item of merchandise. Then, when receiving a change operation of the status on the status image ST, the operation detail transmission unit 354 of the store terminal 30 transmits the store ID of the respective store along with the relevant reception number and the merchandise ID with the changed status to the server apparatus 20 as the operation details. Thereby, in the server apparatus 20, the statuses may be managed by individual items merchandise, and calling of customers may be performed as each item of merchandise becomes available for pickup.

When the statuses are managed by orders, the statuses are held in correlation with the overall order information and the individual reception numbers. Note that in this case different reception numbers are issued for the respective stores. In the order condition window, the status images ST of the cooking condition and the calling condition are displayed with respect to each order as in the above described embodiment. Then, when receiving a change operation of the status on the status image ST, the operation detail transmission unit 354 of a store terminal 30 transmits the relevant store ID, reception number, and merchandise ID with the changed status to the server apparatus 20 as the operation details. Thereby, in the server apparatus 20, the statuses may be managed in units of orders, and calling of customers may be performed by order.

### Modified Example 3

In an embodiment, the server apparatus 20 performs the integrated management of orders of several stores, however, in other examples, the order management may be individually performed at each of the respective stores rather than collectively in the server apparatus 20. In such a case, an information processing apparatus, such as the store terminal 30, placed in each store has certain described functions of the server apparatus 20. A modified example will be explained with the store terminals 30 incorporating certain functions of the server apparatus 20.

The store terminal 30 according to the present modified example includes the menu providing unit 251, order receiving unit 252, order condition management unit 253, order condition provision unit 254, and call processing unit 255 as described above for the server apparatus 20 in conjunction with FIG. 8.

In this case, the menu providing unit 251 provides the menu information indicating the merchandise sold at the store to the user terminal 10. The order condition management unit 253 stores and manages the order information for the store itself in an order management table Tc and updates the status or the like in response to an input operation via the operation unit 308.

Thereby, substantially the same effects as those of an above described embodiment may be obtained and, the management of the ordered merchandise may be efficiently performed at each store.

Note that, in the case of this modified example, the display control unit 352 may be configured to directly display the order condition window from the order condition information generated in the order condition provision unit 254. Further, the order condition management unit 253 may be configured to directly receive the operation details on the order condition window via the operation reception unit 353.

### Modified Example 4

In an embodiment, the server apparatus 20 provides the order condition windows (order condition information) to the store terminals 30 of the respective stores, however, the server apparatus 20 in some examples may also provide the order conditions to the user terminals 10.

For example, the order condition provision unit 254 of the server apparatus 20 may provide the order details of the order information stored in the order management table Tc along with the statuses of the respective stores correlated with the order information to the user terminal 10 from which the order was input.

The display control unit 152 of the user terminal 10 controls the display unit 107 to display, for example, a window in which the respective merchandise ordered to the respective stores are correlated with the statuses of the corresponding stores based on the information provided from the server apparatus 20.

Thereby, the user of the user terminal 10 may confirm the statuses of the ordered merchandise with respect to each store, and may more easily know the time when cooking of the merchandise is completed, the time to pick up the merchandise, etc.

The programs executed in the respective apparatuses of the above described embodiments can be incorporated in a ROM or the like and provided to end users or the like in such a manner. The programs executed in the respective apparatuses of the above described embodiments may be recorded in files in installable forms or executable forms in a non-transitory computer-readable recording media such as CD-ROMs, flexible disks (FDs), CD-Rs, DVDs (Digital Versatile Disks), or the like and provided to end users or the like in such a manner.

In some examples, the programs executed in the respective apparatuses of the above described embodiments may be stored on computers connected to networks such as the Internet and downloaded via the networks and provided to end users or the like in such a manner. The programs executed in the respective apparatuses of the above described embodiments may be configured to be provided or distributed via networks such as the Internet.

While certain embodiments have been described, these embodiments are presented as examples, but not intended to limit the scope of the invention. These novel embodiments may be implemented in other various forms and various omissions, replacements, changes may be made without departing from the scope of the invention. These embodiments or their modifications are within the scope of the invention and within the scope of the invention described in claims and equivalents thereof.

What is claimed is:

1. An information processing apparatus, comprising:
a communication interface for receiving order information from a user terminal, the order information indicating an item of merchandise being order by a user via the user terminal;
a memory unit for storing the received order information in association with a terminal identifier of the user terminal and an order status indicator, the order status indicator identifying one of a plurality of stages in a transaction from order reception to handover of the item to the user; and
a processor configured to:
update the order status indicator associated with the order information in the memory unit in response to an instruction to change an order status that is received via the communication interface from a store terminal, and
transmit a notification to the user terminal when the order status indicator associated with the order information is changed to indicate the item is ready for handover.

2. The information processing apparatus according to claim 1, wherein
a number of previous notifications transmitted to the user terminal is stored in association with the order information, and
the processor is further configured to change a method of transmitting the notification to the user terminal based on the number of previous notifications associated with the order information.

3. The information processing apparatus according to claim 2, wherein the notification is provided as a phone call or an electronic mail message.

4. The information processing apparatus according to claim 1, wherein the notification is provided as a phone call or an electronic mail message.

5. The information processing apparatus according to claim 1, wherein the processor is further configured to acquire menu information from a plurality of stores and transmit the acquired menu information to the user terminal.

6. The information processing apparatus according to claim 1, wherein the processor is further configured to perform settlement processing for the transaction.

7. The information processing apparatus according to claim 6, wherein the processor is further configured to transmit order information received from the user terminal to the store terminal.

8. The information processing apparatus according to claim 7, wherein the processor is further configured to transmit the order information to the store terminal only after the settlement processing for the transaction is successfully completed.

9. The information processing apparatus according to claim 1, wherein the processor is further configured to transmit order information received from the user terminal to the store terminal.

10. The information processing apparatus according to claim 1, further comprising:
a display screen for displaying the order information.

11. A food court order management system, comprising:
a plurality of store terminals, each including a display screen for displaying order status information and updating order status; and
a server device including:
a communication interface for receiving order information from a user terminal, the order information indicating an item of merchandise being order by a user via the user terminal;
a memory unit for storing the received order information in association with a terminal identifier of the user terminal and an order status indicator, the order status indicator identifying one of a plurality of stages in a transaction from order reception to handover of the item to the user; and
a processor configured to:
update the order status indicator associated with the order information in the memory unit in response to an instruction to change the order status that is received via the communication interface from one of the plurality of store terminals, and
transmit a notification to the user terminal when the order status indicator associated with the order information is changed to indicate the item is ready for handover.

12. The food court order management system according to claim 11, wherein the user terminal is a smartphone owned by the user.

13. The food court order management system according to claim 11, wherein the user terminal is mounted to a table.

14. The food court order management system according to claim 11, wherein the processor is further configured to perform settlement processing for the transaction.

15. The food court order management system according to claim 11, wherein the processor is further configured to acquire menu information from the plurality of store terminals and transmit the acquired menu information to the user terminal.

16. The food court order management system according to claim 11, wherein the notification is provided as a phone call or an electronic mail message.

17. A non-transitory, computer-readable storage medium storing program instructions which when executed by an information processing apparatus cause the apparatus to perform a method comprising:
receiving order information from a user terminal, the order information indicating an item of merchandise being order by a user via the user terminal;
storing the received order information in association with a terminal identifier of the user terminal and an order status indicator, the order status indicator identifying one of a plurality of stages in a transaction from order reception to handover of the item to the user;
updating the order status indicator associated with the order information in the memory unit in response to an instruction to change an order status that is received from a store terminal; and
transmitting a notification to the user terminal when the order status indicator associated with the order information is changed to indicate the item is ready for handover.

18. The non-transitory, computer-readable storage medium according to claim 17, the method further comprising:
transmitting order information received from the user terminal to the store terminal.

19. The non-transitory, computer-readable storage medium according to claim 17, wherein the notification is provided as a phone call or an electronic mail message.

20. The non-transitory, computer-readable storage medium according to claim 17, the method further comprising:
performing settlement processing for the transaction.
